(19) United States
(12) Patent Application Publication
(10) Pub. No.: US 2008/0298168 A1
(43) Pub. Date: Dec. 4, 2008

(54) Mixing vessels system and related methods

(76) Inventors: Jill Portman, San Anselmo, CA (US); Gary Shinner, San Anselmo, CA (US)

Correspondence Address: Charles C. Valauskas;VALAUSKAS & PINE LLC, Suite 620, 150 South Wacker Drive, Chicago, IL, 60606, US

(21) Appl. No.: 12/152,718

(22) Filed: May 16, 2008

Related U.S. Application Data
(60) Provisional application No. 60/930,917, filed on May 18, 2007.
(60) Provisional application No. 61/004,547, filed on Nov. 28, 2007.

(51) Int. Cl. B01F 15/02

(52) U.S. Cl. 366/178.3

(57) ABSTRACT

A system and methods for maintaining separation between substances such that the substances can be mixed as needed. The substances may be a liquid or a solid and may be edible or non-edible. More specifically, the present invention is directed to a system and methods that include an apparatus including at least two vessels, an additive vessel and a receiving vessel, for maintaining the separation of the substances and facilitating the mixing of the substances as needed.

This application claims the benefit of U.S. Provisional Application Nos. 60/930,917 filed May 18, 2007 and 61/004,547 filed Nov. 28, 2007.

### FIELD OF THE INVENTION

The present invention generally relates to a system and methods for maintaining separation between substances such that the substances can be mixed as needed. The substances may be a liquid or a solid and may be edible or non-edible. More specifically, the present invention is directed to a system and methods that include an apparatus including at least two vessels for maintaining the separation of the substances and facilitating the mixing of the substances as needed.

### BACKGROUND OF THE INVENTION

There are many devices with and methods by which liquids or solids can be maintained in a separate state and, as needed, combined to produce a different substance or an effect. For example, many combination containers are known that are structured so that one container is affixable or held adjacent to or within a second container and each of the containers designed to hold a liquid or solid. These known combination containers, however, are often complicated structures. Examples of such complicated structures are those that include two containers—one designated a cup or pot and the other a multi-component structure designated a lid or cover. The multi-component lid or cover portions of these known devices typically include a “lug” or “flange”—that is inserted into the cup or pot to permit the lid or cover to be held in place on the cup or pot—and a “shoulder” or similar supporting extension—that permits the lid or cover to rest on the lip of the cup or pot. The complicated details of such structures of known devices increase the expense to manufacture them, increase the cost to consumers, and often permit the devices to be used in only limited circumstances. Some such conventional combination containers are designed to be discarded after one use. Others are intended to be reused such as for food service purposes. However, with respect to the food service devices, once the subject food or beverage is prepared and served, the complicated structures of the many known such combination containers can make them difficult to wash, sanitize, store, and reuse.

A demand therefore exists for a system and methods that is of a simplified construction and that permit substances to be retained, and maintained in a separated state but, as needed by the consumer, to be mixed, together to produce another substance, material, or an effect. The present invention satisfies the demand.

### SUMMARY OF THE INVENTION

The present invention is directed to systems and methods utilizing an apparatus having a simplified construction and by which the separation of substances may be maintained. One embodiment of the present invention includes at least two vessels, each of which is of simplified construction. One of the vessels is termed the “additive vessel” for purposes of this application. The additive vessel is of a simplified construction and is sized and shaped such that it may be received within the other vessel, termed the “receiving vessel” for purposes of this application. The term “nested position” for purposes of this application is that position of the additive vessel relative to the receiving vessel such that the additive vessel is supportively engaged by the receiving vessel. It is explained in greater detail below. The additive vessel may be formed from a material or materials such that the additive vessel may contain at least one substance that is intended to be used in conjunction with the substance contained in the receiving vessel.

As an example, the additive vessel may contain a flavoring or nutritional powder or liquid, which, after removal of the additive vessel from its nested position within the receiving vessel, may be added to the substance within the receiving vessel. The substance in the receiving vessel, for example, may be simply water (heated or cooled), which when mixed with a flavoring or nutritional substance from the additive vessel, may produce a flavored water or other beverage for consumption by one or more consumers. The terms “additive substance” and “receiving substance” for purposes of this application are those substances of the additive vessel and the receiving vessel respectively. The term “final substance” is that which is produced from combining the additive substance with the receiving substance.

The additive vessel includes an additive wall having a generally vertical additive side wall, an additive bottom wall and, opposing thereto, an additive top wall. The vertical additive side wall is joined to the additive bottom wall along additive bottom edge and to the additive top wall along additive top edge.

The receiving vessel includes a receiving wall having a generally vertical receiving side wall, a receiving bottom wall and, opposing thereto, a receiving top wall. The vertical receiving side wall is joined to the receiving bottom wall along receiving bottom edge and to the receiving top wall along receiving top edge.

The additive wall of the additive vessel may include one or more fill lines, for example graduated fill lines, such that the additive substance can be measured by achieving the level that is even with a fill line. Additionally, the receiving wall of the receiving vessel may include one or more fill lines such that the receiving substance can be measured by achieving the level that is even with a fill line. It is contemplated that the additive substance may be measured by achieving the level that is even with a fill line of the receiving vessel, and likewise, the receiving substance may be measured by achieving the level that is even with a fill line of the additive vessel.

With respect to one preferred embodiment of the present invention, the receiving vessel and the additive vessel are complimentarily structured so that the additive vessel may fit within and be supportively engaged by the receiving vessel so that the top wall of the additive vessel is generally adjacent to or slightly below the top wall of the receiving vessel. With respect to another preferred embodiment of the present invention, the receiving vessel includes a fill line such that the additive vessel may fit within and be supportively engaged by the receiving vessel so that the top wall of the additive vessel is generally adjacent to or slightly below the fill line of the receiving vessel. These positions of the additive vessel relative to, and within the receiving vessel will be termed for purposes of this application, “fully nested”.

Another preferred embodiment of the present invention includes an additive vessel that is sized and shaped such that the top wall of the additive vessel is slightly above but adjacent to the top wall of the receiving vessel. With respect to another preferred embodiment of the present invention, the receiving vessel includes a fill line such that the additive vessel may fit within and be supportively engaged by the receiving vessel so that the top wall of the additive vessel is slightly above but adjacent to the fill line of the receiving vessel. For purposes of this application, this position is termed “largely nested”.

An additional preferred embodiment of the present invention includes an additive vessel of a simplified construction that is sized and shaped such that the top wall of the additive vessel is spaced a sufficient distance above the top wall of the receiving vessel so that a consumer can easily grasp the side wall of the additive vessel exposed above the receiving vessel and manipulate the additive vessel as intended. With respect to another preferred embodiment of the present invention, the receiving vessel includes a fill line such that the additive vessel may fit within and be supportively engaged by the receiving vessel so that the top wall of the additive vessel is a sufficient distance above the fill line of the receiving vessel. For purposes of this application, the third position is termed “engagingly nested”. The fully nested position, the largely nested position, and the engagingly nested position, each will be generically identified in the following as a “nested position”.

The complimentary apparatus of the additive vessel and the receiving vessel to facilitate the nested position is such that the additive vessel is supported on and thereby supportively engaged by the receiving inner surface of the receiving vessel. Such retention of the additive vessel by the receiving vessel is termed “supportive engagement” or a similar term herein.

The apparatus of the present invention may be composed of materials that permit the apparatus to be discarded (and/or recycled) largely after a single use and thereby sold in the retail trade for one-time consumption. The apparatus of the present invention may also be composed of materials that are intended to be more permanent and that permit one or both of the vessels to be reused. A system including such an apparatus is more useful for the service of food and beverage in restaurants, institutions, or in the homes of consumers. To illustrate, and with respect to one of the preferred embodiments that includes two vessels, both the receiving vessel and the additive vessel may be made of a material (such as glass, porcelain, a polycarbonate material, or other material) that permits it to be washed and stored for reuse.

Alternatively, the apparatus of the present invention may include vessels, each of which is made from different materials. For example, the additive vessel may be made of a material that permits the additive vessel to be discarded largely after a single use, while the receiving vessel may be made from a material that permits it to be washed, sanitized, and stored, and thereby reused. As stated above, both vessels may be made of materials that permit, cause, and/or require the vessels to be discarded largely after a single use.

The additive vessel may be made of a material that is intended to dissolve or melt such as with contact with the moisture or steam from the liquid in the receiving vessel or upon exposure of the vessel to a treatment such as heating, cooling, microwaving, or simple exposure to ambient conditions. One simple embodiment of such an additive vessel can be formed from sugar. Simple exposure to the liquid in the additive vessel or the steam or moisture from or the liquid in the receiving vessel may cause it to dissolve, thereby adding some flavor to the substance in the receiving vessel.

Additionally, as “nested” within the receiving vessel, the substance within the additive vessel may be thereby treated. For example, if the substance within the receiving vessel is a warm liquid, the heat or steam generated therefrom may heat the substance within the additive vessel. If the substance within the additive vessel is milk or honey, the milk is warmed or the honey becomes less viscous—as many consumers prefer it before adding it into tea or other beverage that may be contained in the receiving vessel.

One advantage of the present invention is that it permits two substances to be maintained in a separated state in a single apparatus.

Another advantage of the present invention is that it permits two substances to be maintained in a separated state in a single apparatus to be mixed easily on an as needed basis.

An additional advantage of the present invention is that it permits a consumer or server to prepare a final substance as needed and, for example with respect to food or beverage, according to the taste of the consumer, guest, or customer.

An added advantage of the present invention is that it encourages a consumer, guest, or customer to be more interactive in the process by which a final product is prepared.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A is an exploded perspective view of one embodiment of the mixing system according to the present invention showing the additive vessel above and positioned to be received in a nested position within the receiving vessel;

FIG. 1B is an exploded perspective view of another embodiment of the mixing system according to the present invention showing the additive vessel and a closure for same positioned to be received in a nested position within the receiving vessel;

FIG. 2 is a perspective view of the embodiment shown in FIG. 1A and FIG. 1B showing the additive vessel in a largely nested position within the receiving vessel;

FIG. 3A is a perspective view of another embodiment of the mixing system according to the present invention in which the receiving vessel includes an egress element by which the substance within the receiving vessel may be removed and that may facilitate the removal of the additive vessel;

FIG. 3B is a perspective view of another embodiment of the mixing system according to the present invention showing the additive vessel in a fully nested position within the receiving vessel;

FIG. 4A is a cross sectional view of another embodiment of the mixing system according to the present invention showing the additive vessel supportively engaged within the receiving vessel in a nested position relative to each other;

FIG. 4B is a cross sectional view of the embodiment shown in FIG. 4A in which the two vessels are nested and sealed; and

FIG. 5 is a perspective view of an additional embodiment of the mixing system according to the present invention in which the additive vessel is sized and shaped relative to the receiving vessel such that the additive vessel is in an engagingly nested position.

### DESCRIPTION OF PREFERRED EMBODIMENTS

A system and methods for maintaining separation between substances such that the substances can be mixed as needed is identified in the accompanying drawings as 21. The substances 23 may be a liquid or a solid and may be edible or non-edible. More specifically, the present invention is directed to a system and methods that includes an apparatus 25 structured and formed from material by which the separation of the substances may be maintained and the mixing of the substances 23 may be facilitated as needed. For convenience of description, terms such as “upper”, “lower”, “outer”, “inner”, “horizontal”, “vertical”, “outwardly”, and “inwardly” are used to refer to the apparatus 25 and the components of the apparatus 25 in an orientation illustrated in the accompanying drawings. However, it will be understood that the embodiments of the invention described in this application advantageously can be used in a variety of orientations.

One preferred embodiment of the system and methods 21 according to the present invention includes a simplified apparatus 25 that includes at least two vessels, an additive vessel 31 and a receiving vessel 71. The vessels 31, 71 are shown in certain of the accompanying illustrations are generally clear. However, the vessels may be made of a variety of materials and be as a result, clear, partially clear, opaque, or colored, or smoky.

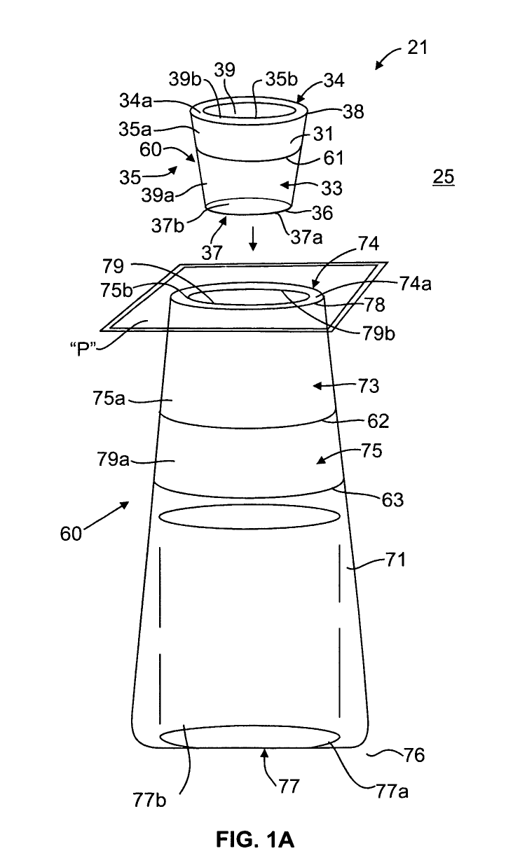

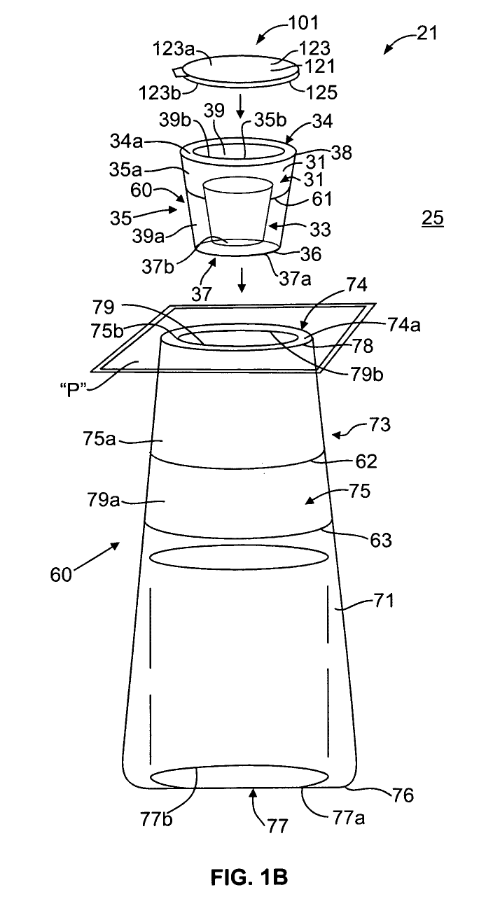

One preferred embodiment of the additive vessel 31 is of a simplified construction and sized and shaped such that it may be received within the receiving vessel 71. More specifically, the embodiment of the additive vessel 31 illustrated in FIG. 1A includes an additive wall 33 configured in this embodiment as having a generally vertical additive side wall 35, an additive bottom wall 37 and, opposing thereto, an additive top wall 34. The vertical additive side wall 35 is joined to the additive bottom wall 37 along additive bottom edge 36 and to the additive top wall 34 along additive top edge 38. The additive vessel 31 may include one or more fill lines 60. As shown in FIG. 1A, the additive wall 33 of the additive vessel 31 includes fill line 61. The additive substance 23 can be measured by achieving the level that is even with a fill line 61. The generally vertical additive side wall 35 includes an additive side outer surface 35A and an additive side inner surface 35B. The additive bottom wall 37 includes an additive bottom outer surface 37A and an additive bottom inner surface 37B. The additive top wall 34 includes an additive top surface 34A. The additive side outer surface 35A and the additive bottom outer surface 37A define an additive outer surface 39A that is preferably configured and has dimensions such that the additive vessel 31 may be received and held in a generally stable nested position 91 within the receiving vessel 71. The additive side inner surface 35B and the additive bottom inner surface 37B form an additive inner surface 39B that defines an inner additive volume 39 that is preferably configured to contain a substance 23.

The embodiment of the receiving vessel 71 illustrated in FIG. 1A includes a receiving wall 73 configured as having a generally vertical receiving side wall 75, a receiving bottom wall 77 and, opposing thereto, a receiving top wall 74. The receiving vessel 71 may include one or more fill lines 60. As shown in FIG. 1A, the receiving wall 73 of the receiving vessel 71 includes fill lines 62, 63 such that the receiving substance 23 can be measured by achieving the level that is even with a fill line 62, 63. The vertical receiving side wall 75 is joined to the receiving bottom wall 77 along receiving bottom edge 76 and to the receiving top wall 74 along receiving top edge 78. The receiving wall 73 may further include a fill line. The generally vertical receiving side wall 75 includes a receiving side outer surface 75A and a receiving side inner surface 75B. The receiving bottom wall 77 includes a receiving bottom outer surface 77A and a receiving bottom inner surface 77B. The receiving top wall 74 includes a receiving top surface 74A. The receiving top wall 74, and more particularly the receiving top surface 74A, forms a generally horizontal plane “P” along which additive vessel 31 of the present invention may or may not be aligned.

The receiving side outer surface 75A and the receiving bottom outer surface 77A define a receiving outer surface 79A. Collectively, the receiving side inner surface 75B and the receiving bottom inner surface 77B form a receiving inner surface 79B that defines an inner receiving volume 79 having a complimentary configuration and dimension such that the additive vessel 31 may be received and held in a generally stable nested position 91 within the receiving vessel 71. Additionally, the inner receiving volume 79 may be configured to contain a substance 23.

The apparatus 25 may include a closure 101 such that the additive vessel 31 and the receiving vessel 71 may be maintained in an easy to use configuration relative to each other. The embodiment of the apparatus 25 shown in FIG. 1B includes an embodiment with a closure 101. The illustrated embodiment of the closure 101 is configured as a cover 121 of the additive vessel 31. Cover 121 may be in the form of a seal 123 having an upper seal surface 123A and a lower seal surface 123B. The lower seal surface 123B may include an adhesive 125 (shown as an enlarged feature in FIG. 1B) by which the seal 123 may be maintained in a releasably fixed position on the additive top wall 34. With the seal 123 in place on the additive vessel 31, the substance 23 is retained within the additive vessel 31 until needed, at which time the seal 123 is partially opened or completely removed to permit the substance 23 to be removed partially or entirely from the additive vessel 31 such as by pouring some or all of the substance 23 within the additive vessel 31 into the receiving vessel 71.

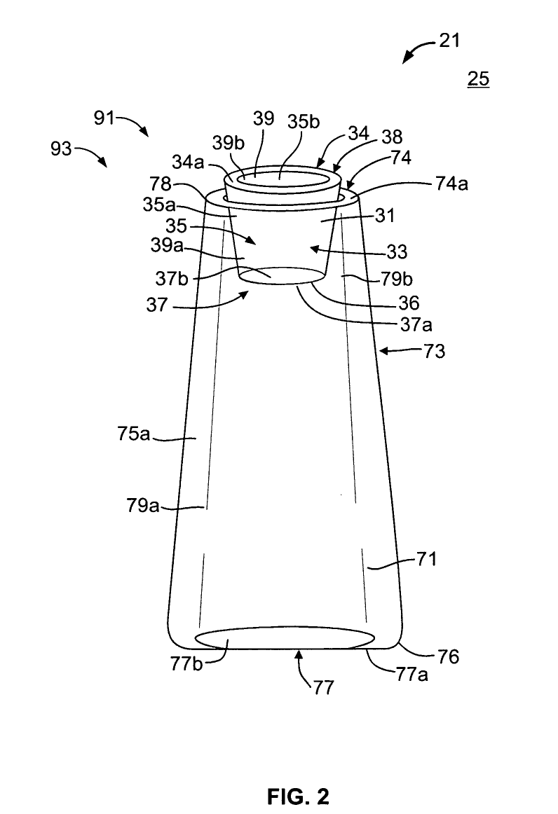

The embodiments of the apparatus 25 include an additive vessel 31 and a receiving vessel 71 which are configured so that the additive vessel 31 is receivable within the receiving vessel 71 and retained in a generally stable nested position 91 as shown in FIG. 2. The additive vessel 31 is held within the inner receiving volume 79 of the receiving vessel 71.

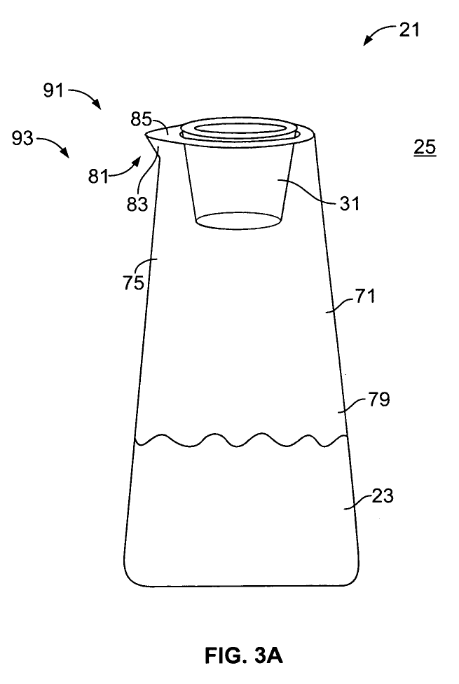

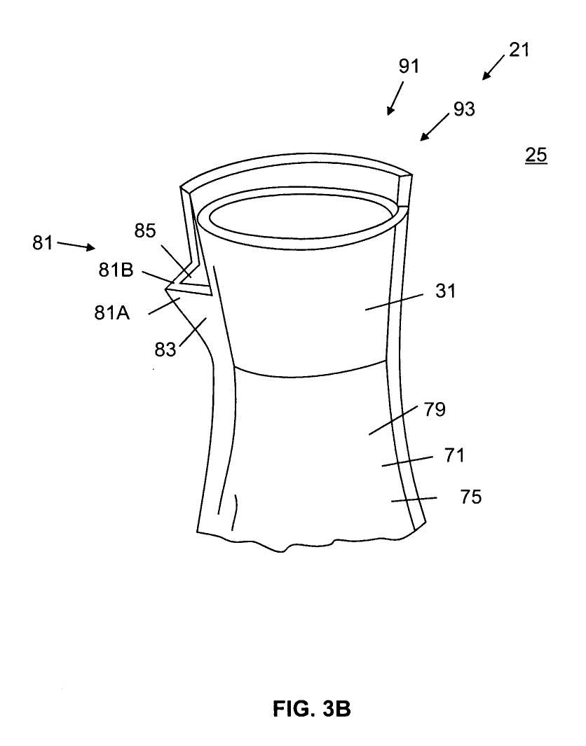

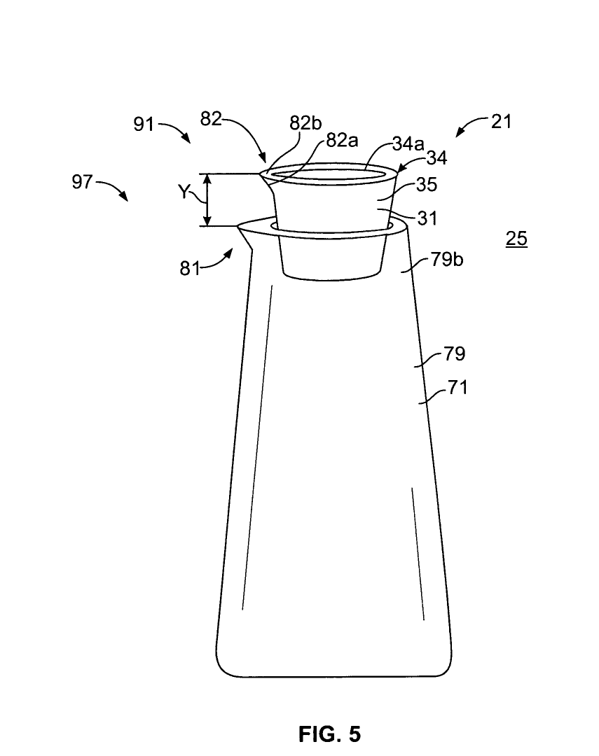

FIG. 3A, FIG. 3B, and FIG. 5 illustrate embodiments of the apparatus 25 that include a receiving vessel 71 having an egress element 81. FIG. 5 additionally illustrates an embodiment of the apparatus 25 that includes an additive vessel 31 having an egress element 82. The egress element 81 of the receiving vessel 71 is sized and shaped to permit a user of the apparatus 25 to gain access to the additive vessel 31, if necessary, and to the inner receiving volume 79 of the receiving vessel 71. In the illustrated embodiment, the egress element 81 allows a user to pour or otherwise remove a receiving substance 23 from the receiving vessel 71. In one embodiment of the egress element 81, the receiving side wall 75 of the receiving vessel 71 is configured as a receiving spout 83 and egress space 85 opens between the additive vessel 31 and the receiving vessel 71.

Other embodiments of the receiving vessel 71 may include an egress element 81 sized and shaped to permit the additive vessel 31 to be removed from the receiving vessel 71 including when the additive vessel 31 is in a fully nested position 95. An example of an apparatus 25 including an egress element 81 that is sized and shaped to facilitate the removal of an additive vessel 31 from a receiving vessel 71 when the additive vessel 31 is in a largely nested position 93 relative to the receiving vessel 71 is illustrated in FIG. 3A.

An example of an apparatus 25 including an egress element 81 that is sized and shaped to facilitate the removal of an additive vessel 31 from a receiving vessel 71 when the additive vessel 31 is in a fully nested position 95 relative to the receiving vessel 71 is illustrated in FIG. 3B. In this embodiment, the egress element 81 includes egress elements 81A, 81B opening symmetrically on opposing sides of the receiving side wall 75. In the illustrated embodiment, the receiving side wall 75 is shaped adjacent to the egress element 81A to form a receiving spout 83 that extends from egress element 81A. An egress space 85 occurs between the receiving spout 83 and the additive vessel 31.

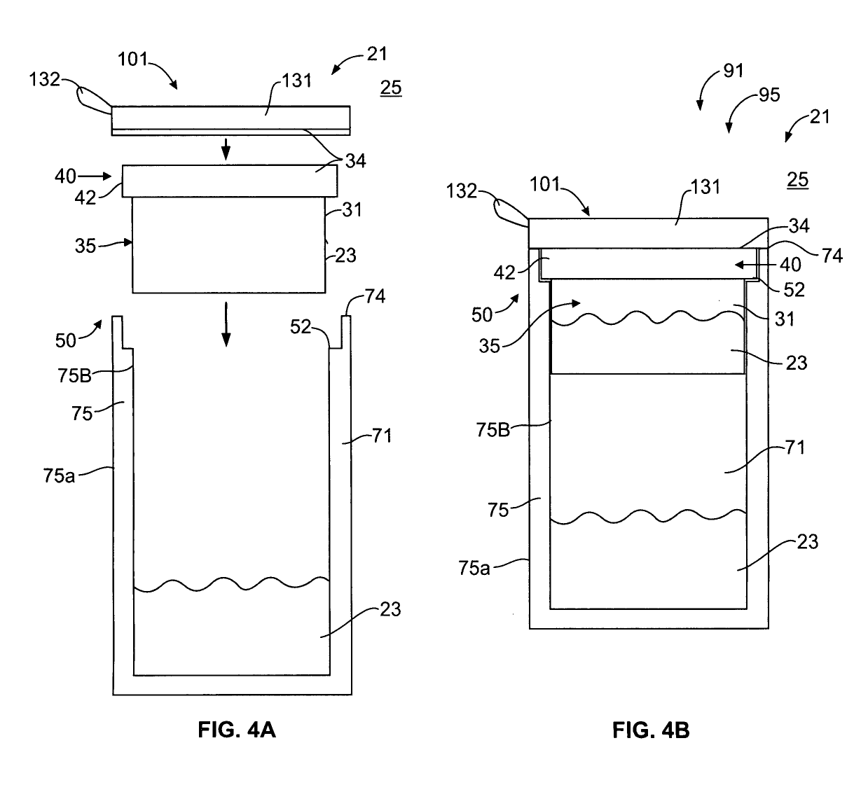

FIG. 4A and FIG. 4B illustrate other embodiments of the apparatus 25 including an additive vessel 31 and a receiving vessel 71. The embodiments of FIGS. 4A and 4B are not necessarily formed with rounded edges. The additive vessel 31 is configured so that it can achieve a fully nested position 95 relative to the receiving vessel 71 so that the additive top wall 34 of the additive vessel 31 in this embodiment is generally adjacent to but not above the receiving top wall 74.

To permit the additive vessel 31 and the receiving vessel 71 to be placed in a fully nested position 95 relative to each other, which is also highly stable, the additive vessel 31 may include a support element 40. Support element 40 is formed from an additive side wall 35 that is enlarged. As shown in FIGS. 4A and 4B, additive side wall 35 is enlarged to form an arm 42. Arm 42 is sized and shaped so that the additive vessel 31 may be supported on appropriately sized and shaped holding element 50 of receiving vessel 71. Holding element 50 is formed from receiving side wall 75, and more particularly from receiving side inner surface 75B. As shown in FIG. 4A and FIG. 4B, holding element 50 is a ridge 52 on inner surface 75B.

The embodiment of the apparatus 25 shown in FIG. 4A and FIG. 4B includes an embodiment of a closure 101 by which the entire apparatus 25 is closed thereby. The closure 101 is in the form of an extended seal 131 that covers the additive top wall 34 and the receiving top wall 74 as shown in FIG. 4B. In this embodiment, seal 131 also includes a tab 132. Tab 132 assists in maintaining the additive vessel 31 and receiving vessel 71 in a nested position 91, and particularly a fully nested position 95.

FIG. 5 is an embodiment of the apparatus 25 wherein the additive vessel 31 includes an egress element 82. In the illustrated embodiment, the egress element 82 allows a user to pour or otherwise remove an additive substance 23 from the additive vessel 31. In one embodiment of the egress element 82, the additive side wall 35 of the additive vessel 31 is configured as an additive spout 84. In this embodiment, the egress element 82 includes egress elements 82A, 82B opening symmetrically on opposing sides of the additive side wall 35.

The nested position 91 in which the additive vessel 31 is held within the inner receiving volume 79 of the receiving vessel 71 is illustrated in FIG. 2, FIG. 3A, FIG. 3B, FIG. 4B and FIG. 5.

FIG. 3B and FIG. 4B illustrate a fully nested position 95 in which the top wall 34 of the additive vessel 31 is generally adjacent to or slightly below the top wall 74 of the receiving vessel 71. More specifically, additive top surface 34A is generally adjacent to or slightly below the generally horizontal plane “P” formed by receiving top surface 74A. It is also contemplated that the receiving vessel 71 includes a fill line 60 such that the additive vessel 31 may fit within and be supportively engaged by the receiving vessel 71 so that the additive top surface 34A of the top wall 34 of the additive vessel 31 is generally adjacent to or slightly below the fill line 60 of the receiving vessel 71. A fully nested position 95 is one in which the additive vessel 31 is fully received within the inner receiving volume 79 defined by the receiving inner surface 79B of the receiving vessel 71.

FIG. 2 and FIG. 3A illustrate a largely nested position 93 in that the additive top wall 34 of additive vessel 31 is above but largely adjacent to the receiving top wall 74 of the receiving vessel 71. More specifically, additive top surface 34A is generally adjacent to or slightly above the generally horizontal plane “P” formed by receiving top surface 74A. It is also contemplated that the receiving vessel 71 includes a fill line 60 such that the additive vessel 31 may fit within and be supportively engaged by the receiving vessel 71 so that the additive top surface 34A of the top wall 34 of the additive vessel 31 is generally adjacent to or slightly above the fill line 60 of the receiving vessel 71. A largely nested position 93 facilitates the removal of the additive vessel 31 from the receiving vessel 71 since a portion of the additive wall 33 of the additive vessel 31 is exposed above the receiving top wall 74 thereby permitting the additive vessel 31 to be removed from supportive engagement by the receiving vessel 71 and further manipulated as needed.

FIG. 5 illustrates an embodiment of the system and methods 21 that includes an apparatus 25 including an additive vessel 31 and receiving vessel 71, each of which is sized and shaped to permit the additive vessel 31 to be in supportive engagement in an engagingly nested position 97. The additive vessel 31 is supported on and thereby supportively engaged by the receiving inner surface 79B of the receiving vessel 71. In such a position 97, the additive top wall 34 and more specifically the additive top surface 34A of the additive vessel 31 is spaced a distance “Y” above the receiving top wall 74 and more specifically the receiving top surface 74A to facilitate the grasping of the additive vessel 31 such as with the fingers of the user. It is also contemplated that the receiving vessel 71 includes a fill line 60 such that the additive vessel 31 may fit within and be supportively engaged by the receiving vessel 71 so that the additive top surface 34A of the top wall 34 of the additive vessel 31 is a sufficient distance above the fill line 60 of the receiving vessel 71.

It will be understood that the embodiments of the present invention, which have been described, are illustrative of some of the applications of the principles of the present invention. Numerous modifications may be made by those skilled in the art without departing from the true spirit and scope of the invention.

What is claimed is:

1. An apparatus for maintaining one or more substances in a separated condition for subsequent use, said apparatus comprising:
an additive vessel including an additive outer surface and an additive inner surface, wherein said additive inner surface is sized and shaped and of a composition for the retention of an additive substance;
a receiving vessel including a receiving outer surface and a receiving inner surface, wherein said receiving inner surface is sized and shaped and of a composition for the retention of a receiving substance, said receiving inner surface forming an inner receiving volume sized and shaped such that said additive outer surface of said additive vessel may be supportively engaged by said receiving inner surface in a nested position.

2. The apparatus of claim 1 wherein said additive vessel includes an additive top wall and said receiving vessel includes a receiving top wall and said additive outer surface is sized and shaped and said receiving inner surface is sized and shaped such that said additive top wall is generally adjacent to or slightly below said receiving top wall.

3. The apparatus of claim 1 wherein said additive vessel includes an additive top wall and said receiving vessel includes a receiving top wall and said additive outer surface is sized and shaped and said receiving inner surface is sized and shaped such that said additive top wall is generally adjacent to or slightly above said receiving top wall.

4. The apparatus of claim 1 wherein said additive vessel includes an additive top wall and said receiving vessel includes a receiving top wall and said additive outer surface is sized and shaped and said receiving inner surface is sized and shaped such that said additive top wall is generally spaced a sufficient distance above said receiving top wall.

5. The apparatus of claim 1 wherein said receiving vessel includes an egress element, wherein said egress element is sized and shaped to permit a user of the apparatus to gain access to said additive vessel.

6. The apparatus of claim 1 wherein said receiving vessel includes an egress element, wherein said egress element is sized and shaped to permit said additive vessel to be removed from said receiving vessel.

7. The apparatus of claim 1 wherein said additive vessel includes an egress element, wherein said egress element is sized and shaped to permit a substance to be poured or otherwise removed from said additive vessel.

8. An apparatus for maintaining one or more substances in a separated condition for subsequent use, said apparatus comprising:
an additive vessel including an additive side wall and an additive top surface, wherein said additive side wall forms a support element and said additive vessel is sized and shaped and of a composition for the retention of an additive substance;
a receiving vessel including a receiving side wall and a receiving top surface, wherein said receiving side wall forms a holding element and said receiving vessel is sized and shaped and of a composition for the retention of a receiving substance, said holding element engages with said support element such that said additive vessel and said receiving vessel are supportively engaged in a nested position.

9. The apparatus of claim 8 wherein said additive top surface is sized and shaped such that said additive top surface is generally adjacent to or slightly below said receiving top surface.

10. The apparatus of claim 8 wherein said additive top surface is sized and shaped such that said additive top surface is generally adjacent to or slightly above said receiving top surface.

11. The apparatus of claim 8 wherein said additive top surface is sized and shaped such that said additive top surface is generally spaced a sufficient distance above said receiving top surface.
